(19) United States
(12) Patent Application Publication
(10) Pub. No.: US 2017/0287058 A1
(43) Pub. Date: Oct. 5, 2017

(54) System, Method, and Apparatus for Visually Facilitating Customer Orders

(71) Applicant: Nima Pedram, Beverly Hills, CA (US)

(72) Inventor: Nima Pedram, Beverly Hills, CA (US)

(21) Appl. No.: 15/085,517

(22) Filed: Mar. 30, 2016

(51) Int. Cl. G06Q 30/06

(52) U.S. Cl. CPC G06Q 30/0643; G06Q 30/0623

(57) ABSTRACT

A system, method, and apparatus are provided which aid consumers in making purchasing decisions by presenting them with sortable, photographic listings of individual goods offered by independently operating service providers, especially food menu items prepared at unrelated restaurants. Upon receiving a user's selection of an item depicted at a mobile device, the system may present a potential consumer with specifications characterizing the item, crowd-sourced photos substantiating the appearance of the item in the initially presented photo, and reviews of the item serving to critique or recommend the item to the potential customer. In the event that a user intends to purchase any of the items presented, the system may further enable the user to make a reservation with their respective providers to attain the items, to place an order to have the items delivered, and even to hold the items for in-person pickup.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material that is subject to copyright protection. This patent document may show and/or describe matter that is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to crowd-sourcing reviews for goods and services, more particularly, to methods, systems, and apparatuses that present potential customers with photos of individually reviewed items, such as food items, and directly connect prospective customers to means enabling them to purchase such items.

### BACKGROUND

As technology that enables wireless communication and enhances local and global connectivity continues to develop, many consumers find it easier than ever to rely on others' aggregated reviews before purchasing a variety of goods and services. Where previously, recommendations and criticisms were made to limited audiences, as between personal acquaintances and sometimes in circulated print, the Internet now makes it possible to collect and search various impressions that consumers might have supplied in an effort to both aid potential consumers making their purchase, as well as communicate concerns and compliments to the good or service provider.

As such, some websites and mobile phone applications for collecting and enabling searches of reviews of local food service providers, including restaurants and other eateries, are known. On such platforms, consumer reviews are often aggregated to provide an overall impression of a single location. For instance, consumers may submit reviews or ratings on predetermined scales that include criticism and/or praise for any of ambiance, food quality, quality of service, amenities, and others. Unfortunately, determining how particular menu items offered by the establishment contribute to any given review or rating can be difficult to ascertain. As an example, some platforms permit customers to submit free-form explanations of their submitted ratings. Some consumers choose to recommend or criticize individual menu items at such point. Potential consumers interested knowing how others perceived particular items must then manually search through submitted reviews, which may or may not include information about the items the potential customer is hoping to ascertain.

Additionally, although some items offered by a single provider may receive significant criticism, others offered by the same provider may be generally well-liked yet go unremarked on reviewing platforms. As a result, potential consumers may be less likely to try, if not entirely avoid, patronizing the provider on account of subjective impressions that may be capable of negatively skewing the perceived quality of the provider.

Some attempts have been made to address these problems. U.S. Pat. Pub. No. 2012/0179552 filed by Tishkevich, for example, suggests enhancing usefulness of consumer-submitted reviews by filtering searches to show products that are positively rated within a user's social network and demographic. This proposal is deficient, though, because its predictive nature may operate to prevent users from seeing goods they might find potentially desirable. This may also have the effect of limiting a provider's pool of potential customers.

As still another example, U.S. Pub. No. 2010/0017265 filed by Weingarten et al. discloses systems for comparing objective characteristics among like products—including foods—such as ingredients and social, ecological, and political impact of manufacturing such products, and making recommendations to potential buyers based on those characteristics. This, however, is deficient because it fails to provide users with aggregated consumer impressions, especially those related to subjective satisfaction. Furthermore, it fails to provide consumer-backed corroboration of quality assurance claims, which can be useful in ensuring continued sales of high quality goods.

As another example, U.S. Pat. Pub. No. 2007/0214052 filed by Kao teaches interactive communication between restaurants and their customers to improve quality assurance. This is deficient as well though, because, being specific to individual restaurants, it fails to make potential consumers aware of similar, possibly more highly rated, offerings available from other restaurants.

Although various proposals have been made to solve the problem, none of those in existence combine the characteristics of the present invention. Therefore, there is a need for systems, methods, and apparatuses that enable crowd-sourcing item-specific reviews and searches for individual items across various, independently operating providers of goods and services and further facilitating a consumer's order of any goods selected therefrom.

### SUMMARY

The present disclosure is directed to systems, methods, and apparatuses for visually facilitating customer orders by providing sortable images—such as photos—of potentially desirable goods from a plurality of independently operating providers, aggregating customer-submitted evidence of the quality of such goods, and facilitating purchasing such goods on behalf of potential consumers.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In one embodiment, among others, a system is provided that comprises a mobile device operative to first display one or more images of individual items respectively purchasable from any of a plurality of independently operating providers. In some embodiments, the goods are individually listed, consumable food and drink, or menu items, that are offered for sale by various food service providers, including sit-down and fast-food restaurants, bakeries, coffee shops, and other eateries. It should be noted that although menu items and food service providers are discussed herein, other goods are contemplated and may be similarly pictorially listed and reviewed. Thus, any mention of food as goods and restaurants as providers of the goods herein is offered by way of example only, and not of limitation. Additionally, it is contemplated that presenting items offered by a variety of independent providers may have the effect of both increasing the satisfaction of consumers who may not wish to be limited even to very well reviewed offerings of a single inter-related chain or family of eateries as well as encouraging various eateries to offer goods that are better liked by, or more satisfying to, consumers.

Thus, in accordance with one embodiment, one or more images of individual menu items may be presented as a photographic listing. A user of the system then may view, in succession, or as a navigable grid or other arrangement, a plurality of photos, each depicting a single menu item available for purchase from a variety of restaurants. Indeed, it is even contemplated that the items may be searchable. For example, where the items are consumable menu items comprising food and drink, the mobile device may be operative to receive commands to filter the listing. Filters may include, for example only and not limitation, type of menu item, price of menu item, the distance of the provider of the item from the potential consumer, magnitude of the crowd-sourced rating for the item, caloric content, and even types of ingredients comprising the menu item.

Having optionally filtered the pictorial or photographic listing, then, the mobile device may be operative to receive a selection of an image depicting a purchasable item. Then, in response to receiving a selection of one of the images, the mobile device may be operative to: display one or more specifications characterizing the item depicted in the selected image, display any customer-submitted images corresponding to the item depicted in the selected image, and display any customer-submitted reviews corresponding to the item depicted in the selected image. It is contemplated that customer-submitted images and customer-submitted reviews may be received from at least one other mobile device, such as a prior customer's mobile device.

Upon receiving a user's selection of a depicted item, the mobile device may present a potential consumer with specifications characterizing the item. In the event that the item is an edible menu item, specifications may comprise, for example and without limitation, the price and name of the item. Other specifications are contemplated, though. For example, many potential consumers value the convenience of local dining. Thus, specifications may further comprise the physical distance that the provider associated with the selected item is located away from the potential consumer's location at any given time.

It is contemplated that images submitted by past customers who have consumed the selected item and corresponding to the item depicted in the selected image may corroborate, substantiate, or otherwise provide relatively un-biased evidence of the appearance of the item in the initially presented image or photo. This may be particularly valuable to potential consumers in the event that images of the purchasable items have been obtained from the providers of the items themselves.

Finally, one skilled in the art will recognize that various types of reviews and means of quantifying reviews of goods and services exist. For example, reviews may comprise ratings depicted as fractions of possible positive points, as percentages of the same, and even as free-form essays. Reviews may even comprise a combination of weighted factors. Thus, it will be understood that the particular form and content of crowd-sourced reviews may vary. In any event, reviews crowd-sourced from prior customers who have consumed a selected item may serve as un-biased critics or recommenders of the item, which may be useful to a potential consumer contemplating purchase.

In the event that a user intends to purchase any of the items presented by the mobile device, the mobile device may be further operable to facilitate purchasing or otherwise attaining the item or other selected items on behalf of the user. In one embodiment, for example, the mobile device may be operative to make a reservation for the user to enjoy the selected item at its respective provider's location. In another embodiment, the mobile device may be operative to enable placing an order to have the any selected items delivered to a location specified by the user. In still another embodiment, the mobile device may be operative to enable placing an order to hold any selected items for in-person pickup.

In addition to the foregoing, in some embodiments, the system for visually facilitating customer orders may comprise a mobile device operable to operative to: receive and store information for identifying a customer; and receive photos and reviews corresponding to an item presented in the visual listing the identified customer. In one embodiment, this may allow consumers to keep track of personally favored and disfavored items, which may be easily associated with their identifying information.

However, it is also contemplated that, responsive to receiving photos and reviews corresponding to an item presented in the visual listing, the mobile device may be further operative to provide the identified customer with a reward for contributing to searchable and crowd-sourced reviews. For instance, coupons, freebies, and other perks may be rewarded to identified customers who contribute their own photos for substantiating the visual listing or even submit meaningful reviews for potential consumers to review in advance of purchasing pictorially represented items. It is contemplated that incentivizing consumer contribution to the system in this manner may cause consumers to patronize establishments they would have otherwise avoided for reasons separate from the quality and general satisfaction afforded by specific offerings, and in turn influence an overall increase in quality of goods with the promise of good reviews that draw in new, or even higher volume of sales.

Another embodiment of the system, method, and apparatus for visually facilitating customer orders is a computer-readable medium having stored thereon computer-executable instructions, which, when executed by a computer processor, enables performance of a computer-implemented method comprising the steps of: displaying, at a first mobile device, one or more images of individual items, such as food and drink offered on a menu, that are respectively purchasable from any of a plurality of independently operating providers; and receiving, at an at least one other mobile device, one or more customer-submitted images and one or more customer-submitted reviews respectively corresponding to at least some of the one or more images. Then, responsive to receiving, at the first mobile device, a selection of one of the one or more images: displaying, at the first mobile device, one or more specifications characterizing the item depicted in the selected image; displaying, at the first mobile device, any customer-submitted images and/or reviews respectively corresponding to the item depicted in the selected image; and displaying, at the first mobile device; and finally receiving instructions, at the first mobile device, to facilitate purchasing or ordering any of the individual items on behalf of a prospective customer.

Thus, it is one object of the invention to present potential consumers with reviews that are representative of the quality of specific goods, such as food items listed on a menu, that they intend to consume.

It is another object of the invention to crowd-source images of particular goods, such as specific food offerings listed on a menu, from customers to substantiate other reviews and advertisements.

It is also an object of the invention to present potential consumers with like-items, such as types of foods, offered by a variety of providers to enable consumption that may be optionally driven by prior consumers' reviews.

It is yet another object of the invention to directly connect potential consumers with means for attaining reviewed items, such as through delivery or reservation services.

It is still another object of the invention to enable rewards-based interaction between providers, such as restaurateurs, and potential consumers.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 is a blocked diagram of a networked environment in which an exemplary embodiment of a system for visually facilitating customer orders is implemented.

FIG. 2 is a flowchart depicting an exemplary embodiment of a method for visually facilitating customer orders performed by the system illustrated in FIG. 1.

FIG. 3 illustrates an exemplary embodiment of a mobile device shown in FIG. 1.

FIG. 4 is a flowchart illustrating an exemplary user interface according to one embodiment.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

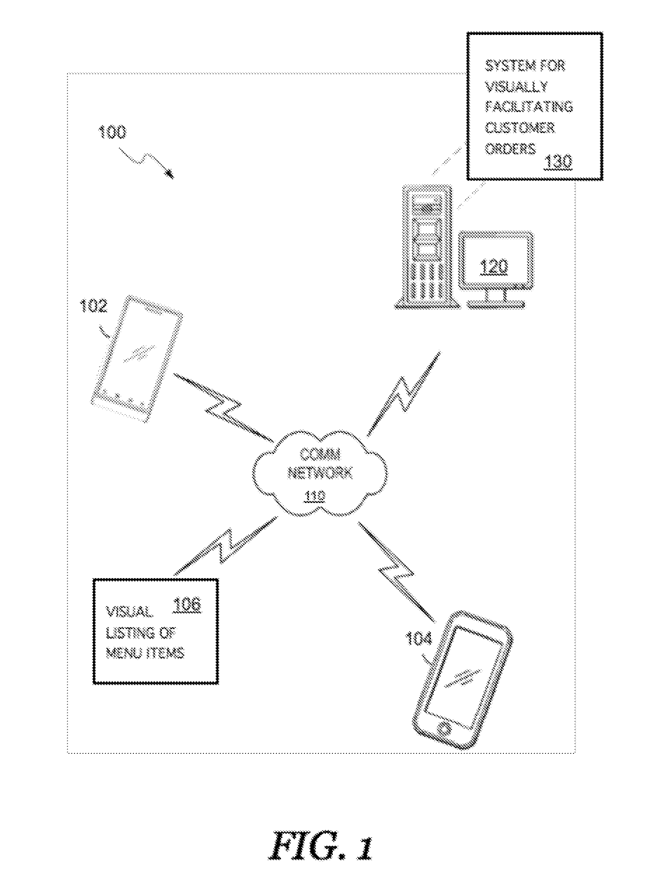

With reference to FIG. 1, an exemplary networked environment in which one embodiment of a system for visually facilitating customer orders is implemented is shown. By way of example, and not limitation, system 100 comprises a plurality of mobile devices, such as mobile devices 102 and 104, that are communicatively coupled via a communication network 110. Each of the mobile devices may be embodied as a mobile computing device such as, for example, and without limitation, a smartphone that incorporates cellular telephone functionality. Notably, the communications network can use one or more of various communications types such as, for example and without limitation, cellular and Wi-Fi communications.

Users of the mobile devices 102 and 104 may be any of potential, prior and even repeat customers of providers offering various items for sale. Users of mobile devices 102 and 104 may be linked in a communication network 110 granting access to a visual listing of items 106. In some embodiments, the items are individually listed consumable food and drink, also known as menu items, that are offered for sale by various food service providers, including sit-down and fast-food restaurants, bakeries, coffee shops, and other eateries. Although menu items and food service providers are discussed explicitly herein, one skilled in the art will recognize that other goods are contemplated and may be similarly pictorially or photographically listed, searched, and reviewed. Thus, any mention of food as goods or items and restaurants as providers of the goods or items herein is offered by way of example only, and not of limitation.

In some embodiments, a pictorial item listing may be a photograph of a particular menu item. Thus, consumers and prospective customers, who are also users of the mobile devices 102 and 104, may use their devices to view photographs of one or more of purchasable menu items from a variety of unrelated restaurants, conveniently experiencing visual reference to an item that they might wish to order. Users of mobile devices 102 and 104 may further submit their own photos of menu items for comparison and even submit reviews of the same.

In this exemplary embodiment, the communication network may be facilitated by a website or mobile phone application hosted by server 120. As such, the server 120 permits access to, and thus viewing of, the various information associated with the photographically listed, purchasable items.

Through the server 120, a user of the system then may view a plurality of photos depicting actual menu items as they might appear if the user were to order them from the provider. It is contemplated that each photo may depict a single menu item available for purchase from a variety of restaurants so that no menu item is either negatively affected by another's bad review or artificially lauded as a result as another's recommendation.

The mobile device 102, 104 may be operative to present the photos to the user in succession, or as a navigable grid, or in any other arrangement.

In some embodiments, users may use their mobile device 102, 104 to search for particular items among the entire pictorial listing. For example, where the items are consumable menu items comprising food and drink, the mobile device 102, 104 may be operative to receive commands to filter the listing according to, for example only and not limitation, type of menu item, price of menu item, the distance to the provider of the item from the potential consumer, magnitude of the crowd-sourced rating for the item, caloric content, and even types of ingredients comprising the menu item.

The mobile device 102, 104 may be operative to receive from the user a selection of any of the photographs listed, or in other words, an image depicting a purchasable item. Upon receiving a user's selection of a depicted item, the mobile device 102, 104 may present a potential customer, or user of the mobile device 102, 104 with specifications characterizing the item. In the event that the item is an edible menu item, specifications may comprise, for example and without limitation, the price and name of the item. Other specifications are contemplated, though. For example, many potential consumers value the convenience of local dining. Thus, specifications may further comprise the physical distance that the provider associated with the selected item is located away from the potential consumer's location at any given time.

It is contemplated that images submitted by past customers who have consumed the selected item and corresponding to the item depicted in the selected image may corroborate, substantiate, or otherwise provide relatively un-biased evidence of the appearance of the item in the initially presented image or photo. This may be particularly valuable to potential consumers in the event that images of the purchasable items have been obtained from the providers of the items themselves.

It is further contemplated that customer-submitted images and customer-submitted reviews may be received from at least one other mobile device, such as a prior customer's mobile device.

It should be noted that one skilled in the art will recognize that various types of reviews and means of quantifying and/or qualifying reviews of goods and services exist. In some embodiments, reviews may comprise ratings depicted as fractions of possible positive points, as percentages of the same, as free-form essays, and even as a combination of weighted factors. As such, the particular form and content of crowd-sourced reviews accessible to a user of the mobile device 102, 104 may vary.

In the event that a user intends to purchase any of the items presented via their mobile device 102, 104, the mobile device may be further operable to directly provide or else communicatively link the user to means for purchasing any menu items.

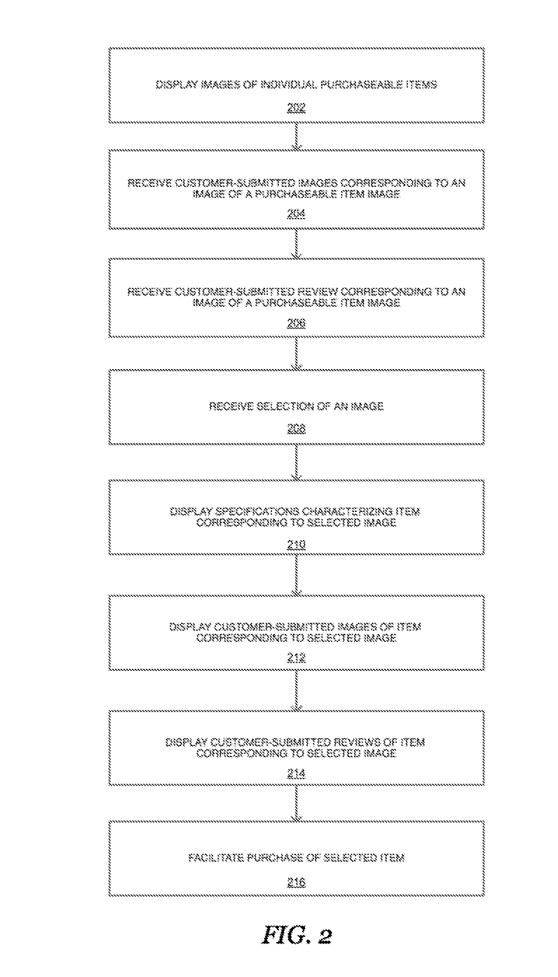

Additionally, server 120 may implement the system for visually facilitating customer orders and, more particularly, implements the steps outlined in FIG. 2. Indeed, FIG. 2 is a flowchart depicting an exemplary embodiment of a system and method for visually facilitating customer orders as may be performed by mobile devices 102 and 104 of FIG. 1. As shown in FIG. 2, the method includes the steps of: displaying images of individual purchasable items (block 202); receiving customer-submitted images corresponding to an image of a purchasable item (block 204); receiving customer-submitted review corresponding to an image of a purchasable item (block 206); receiving a selection of an image corresponding to a purchasable item (block 208); displaying specifications characterizing the item corresponding to the selected image (block 210); displaying customer-submitted images of the item corresponding to the selected image (block 212); displaying customer-submitted reviews of the item corresponding to the selected image (block 214); and facilitating a consumer's purchase of the selected item (block 216).

In order to facilitate the aforementioned functionality, various aspects may be performed by one or more of the mobile devices 102, 104. In an embodiment, for example a mobile device is operative to perform, at least in part, the method discussed with reference to FIG. 2, above.

The aforementioned functions can be performed by various components in various embodiments. For example, the functionality can be highly distributed across a network or less so by use of functions performed on local devices such as 102 and 104.

If embodied in software, it should be noted that each block depicted in the accompanying flowcharts represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as the mobile devices 102, 104. The machine code may be converted from the source code, etc. If embodied in hardware, each block may represent a circuit or a number of interconnected circuits to implement the specified logical function(s). Additionally, although the flowcharts show specific orders of execution, it is to be understood that the orders of execution may differ.

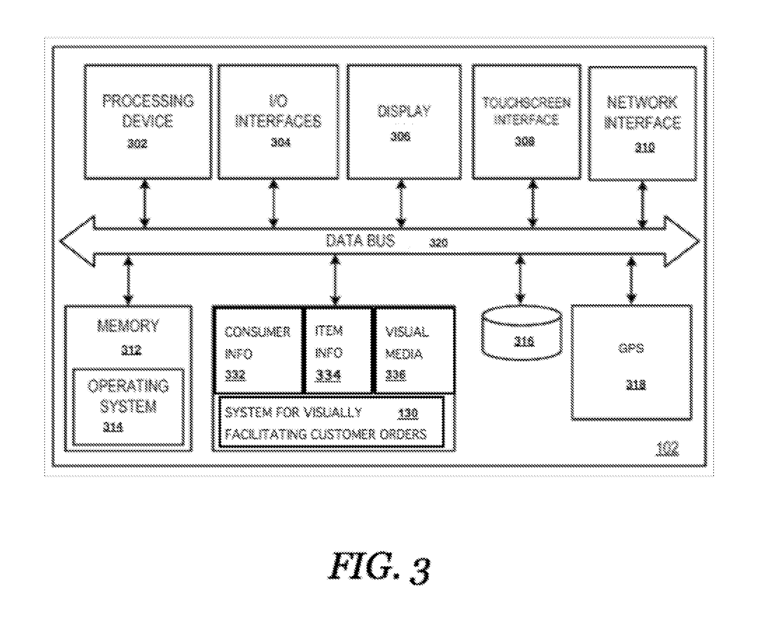

FIG. 3 illustrates mobile device 102 shown in FIG. 1. As described earlier, mobile device 102 may be a tablet computer or smartphone but may also be embodied in any one of a wide variety of wired and/or wireless computing devices. As shown in FIG. 3, mobile device 102 includes a processing device (processor) 302, input/output interfaces 304, a display 306, a touchscreen interface 308, a network interface 310, a memory 312, and operating system 314, a mass storage 316 and an GPS 318, with each communicating across a local data bus 320. Additionally, mobile device 102 incorporates a system for visually facilitating customer orders 100, which is depicted as including consumer information 332, item information 334 and multimedia information 336, although the location of information 332, 334 and 336 could vary.

The processing device 302 may include any custom made or commercially available processor, a central processing unit (CPU) or an auxiliary processor among several processors associated with the mobile device 102, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 312 can include any one of a combination of volatile memory elements (e.g., random-access memory (RAM, such as DRAM, and SRAM, etc.)) and nonvolatile memory elements. The memory typically comprises native operating system 314, one or more native applications, emulation systems, or emulated applications for any of a variety of operating systems and/or emulated hardware platforms, emulated operating systems, etc. For example, the applications may include application specific software which may comprise some or all the components of the mobile device 102. In accordance with such embodiments, the components are stored in memory and executed by the processing device. Note that although depicted separately in FIG. 3, the system and method for coordinating visits 100 may be resident in memory such as memory 312.

Touchscreen interface 308 is configured to detect contact within the display area of the display 306 and provides such functionality as on-screen buttons, menus, keyboards, etc. that allows users to navigate user interfaces by touch. For some embodiments, the mobile device 102 will comprise GPS 318 or other means to determine the location of the mobile device 102.

One of ordinary skill in the art will appreciate that the memory 314 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 3, network interface device 310 comprises various components used to transmit and/or receive data over a networked environment such as depicted in FIG. 1. When such components are embodied as an application, the one or more components may be stored on a non-transitory computer-readable medium and executed by the processing device.

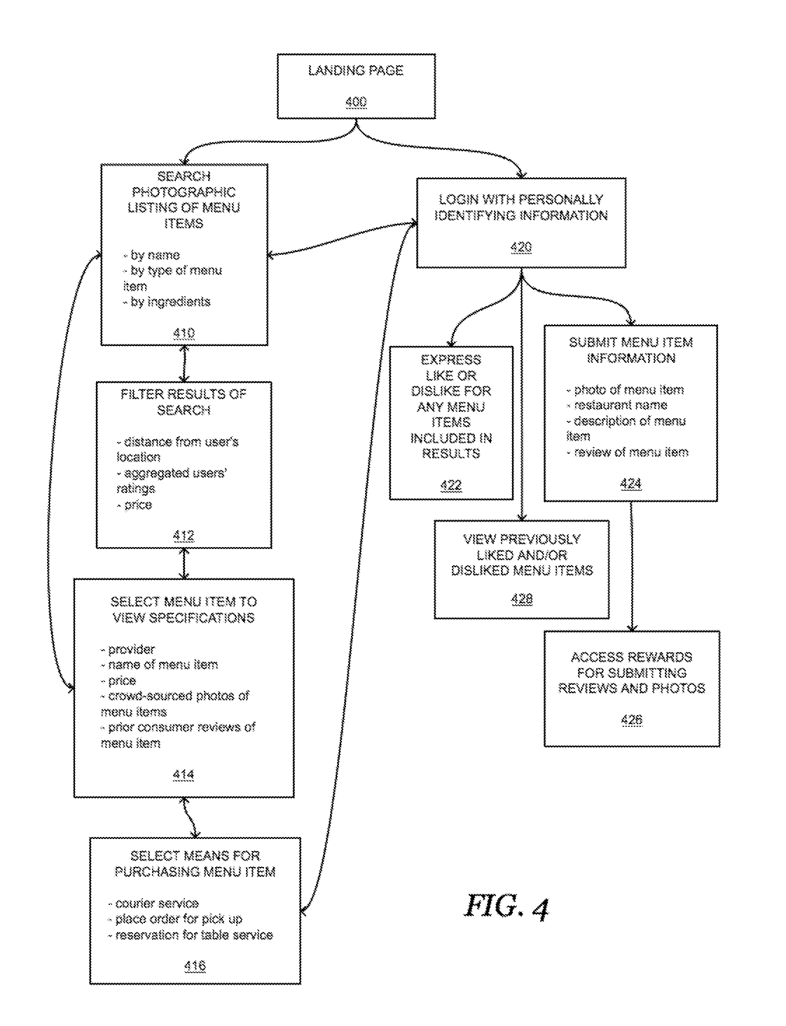

With reference to FIG. 4, one embodiment of an apparatus adapted to implement the system and method for visually facilitating customer orders may enable a potential or returning customer to: search a database of visually represented items available for purchase, input personally identifying information, submit reviews—including photos—of the visually represented items available for purchase, receive rewards for submitting reviews of such items, and selecting means for purchasing visually represented items.

For the sake of brevity and to ease understanding, an exemplary user interface is illustrated as a flowchart in FIG. 4. The exemplary user interface is drawn toward food service providers and consumable food and beverage menu items in particular, however, it is to be understood that other purchasable goods may be similarly depicted and accessible to the consuming public. Thus, in accordance with one embodiment, from a home or landing page 400 a user, typically a consumer or potential customer, may chose to search a photographic listing of menu items 410.

The photographic listing of menu items 410 may comprise photos of each menu item available for purchase through embodiments of the system described above. In one embodiment, such photos may be provided by independently operating food service providers. In another embodiment, such photos may be provided by prior consumers of the menu items. In still another embodiment, such photos may comprise a combination of the two.

Each of the menu items provided in the visual listing may comprise searchable characteristics such as a menu item name, a type of menu item, and even ingredients, among others. Thus, for example, it is contemplated that using their mobile device, consumers may search the photographic listing for different types of menu items such as sandwiches, pizza, pasta, sushi, ramen, barbecue, breakfast, etc. Likewise, consumers may search for specific menu item names such as chicken marsala, paella, sweet potato hash, shepherds pie, steak tartare, and others. Additionally, consumers may search for menu items containing certain ingredients, such as, for example and without limitation, cheese, curry, sweet potatoes, cauliflower, onions, etc.

Consumers may then instruct the system to filter results of the search 412 such as, for example and without limitation, by the distance between the provider and user's location, by the magnitude of aggregated users' ratings, and even by price of the items.

Then, a consumer or user may select an item from the filtered results to view various specifications characterizing that item 414. It may be noted that a user may also make a selection directly from an initial listing of items 410, before any filtering has occurred. Specifications that may be included to define each menu item may comprise any of, for example and without limitation, the name of the provider of the item such as a restaurant name, name of the item, price of the item, crowd-sourced photos of the item, and even prior consumers' reviews of the item. It is contemplated that providing such specifications after showing a potential consumer a photo associated with the item may prevent the user from exercising bias against a particular item based on such characteristics alone yet still aid the user in determining whether he would like to purchase an item that was at least initially visually appealing. It is also contemplated that providing specifications that include consumer photos and reviews may substantiate any desirability induced by the photographic listing of the item. It is even further contemplated that presenting each item individually and independently from its source provider may encourage consumers to patronize a provider that they might have otherwise avoided for reasons unrelated to the quality or desirability of a selected item.

Having made a selection 414, a user may then be directed to select means for purchasing a menu item 416. Such means may include, for example, a courier service for delivering any selected items directly to a user, a reservation service which may enable a user to dine-in at a restaurant offering any selected items, and even a holding service that allows a user to retrieve any selected items in-person.

In addition to the foregoing, in some embodiments, users may provide identifying information 420. In one embodiment, this may allow consumers personally express like or dislike 422 for a particular item and even view, or keep track of, previously like and/or disliked menu items 428.

Users may also submit information relating to menu items 424 such as their own photos, description, and reviews of the items. It is also contemplated that, users may be rewarded for contributing to searchable and crowd-sourced reviews.

In some embodiments, users may access rewards 426 comprising, for example and no limitation, coupons, freebies, and other perks. These may be awarded upon completion of predetermined activities or even at the discretion of the food service providers. In some embodiments, rewards may be provided to identified customers who have contributed their own photos to substantiate a particular photographic listing of a menu item, or have even submitted meaningful reviews for potential consumers to consider in advance of purchasing pictorially represented items.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, although food and beverage items are offered as an example of items subject to this method, orders for other items may be visually facilitated in like manner. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system, method, and apparatus for visually facilitating customer orders with which that terminology is associated. In general, the terms used in the following claims should not be constructed to limit the system, method, and apparatus for visually facilitating customer orders to the specific embodiments disclosed in the specification unless the above description section explicitly define such terms. Accordingly, the actual scope encompasses not only the disclosed embodiments, but also all equivalent ways of practicing or implementing the disclosed system, method, and apparatus for visually facilitating customer orders. The above description of embodiments of the system, method, and apparatus for visually facilitating customer orders is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method, system, and apparatus disclosed are presented below in particular claim forms, various aspects are contemplated in any number of claim forms. Thus, the inventor reserves the right to add additional claims after filing the application to pursue such additional claim forms for other aspects of the system, method, and apparatus for visually facilitating customer orders.

What is claimed is:

1. A method for visually facilitating customer orders, comprising:
displaying, at first a mobile device, one or more images of individual items respectively purchasable from any of a plurality of independently operating providers, the one or more images of the individual items presented as a photographic listing;
receiving, from at least one other mobile device, one or more customer-submitted images respectively corresponding to at least some of the one or more images;
receiving, from at least one other mobile device, one or more customer-submitted reviews respectively corresponding to at least some of the one or more images;
responsive to receiving, at the first mobile device, a selection of one of the images:
a) displaying, at the first mobile device, one or more specifications characterizing the item depicted in the selected image;
b) displaying, at the first mobile device, any customer-submitted images corresponding to the item depicted in the selected image; and
c) displaying, at the first mobile device, any customer-submitted reviews corresponding to the item depicted in the selected image; and
receiving instructions, at the first mobile device, to facilitate purchasing any of the individual items on behalf of the prospective customer.

2. The method of claim 1, further comprising receiving and storing, at the first mobile device, information for identifying a customer.

3. The method of claim 2, further comprising receiving, from the first mobile device, information corresponding to an item presented in the visual listing.

4. The method of claim 3, wherein information corresponding to an item presented in the visual listing is any of a photo of the item captured by the identified customer, and a review addressing the identified customer's satisfaction with the item.

5. The method of claim 4, further comprising, responsive to receiving, at the first mobile device, information corresponding to an item presented in the visual listing, providing the identified customer with a reward.

6. The method of claim 1, wherein the individual items comprise individual food and drink offerings from a menu.

7. The method of claim 1, wherein the providers are food service providers.

8. A system for visually facilitating customer orders comprising:
a mobile device operative to:
display one or more images of individual items respectively purchasable from any of a plurality of independently operating providers, the one or more images of the individual items presented as a photographic listing;
responsive to receiving a selection of one of the images:
a) display one or more specifications characterizing the item depicted in the selected image;
b) display any customer-submitted images, received from at least one other mobile device, corresponding to the item depicted in the selected image; and
c) display any customer-submitted reviews, received from at least one other mobile device, corresponding to the item depicted in the selected image; and
receive instructions to facilitate a prospective customer to means for attaining any of the individual items.

9. The system of claim 8, wherein the mobile device is further operative to receive and store, information for identifying a customer.

10. The system of claim 9, wherein the mobile device is further operative to receive information corresponding to an item presented in the visual listing.

11. The system of claim 10, wherein information corresponding to an item presented in the visual listing is any of a photo of the item captured by the identified customer, and a review addressing the identified customer's satisfaction with the item.

12. The system of claim 11, wherein, responsive to receiving information corresponding to an item presented in the visual listing, the mobile device is further operative to provide the identified customer with a reward.

13. The system of claim 8, wherein the individual items comprise individual food and drink offerings from a menu.

14. The method of claim 8, wherein the providers are food service providers.

15. A non-transitory, tangible computer-readable medium having stored thereon computer-executable instructions, which, when executed by a computer processor, enable performance of the method comprising:
displaying, at a first mobile device, one or more images of individual items respectively purchasable from any of a plurality of independently operating providers, the one or more images of the individual items presented as a photographic listing;
receiving, at an at least one other mobile device, one or more customer-submitted images respectively corresponding to at least some of the one or more images;
receiving, at an at least one other mobile device, one or more customer-submitted reviews respectively corresponding to at least some of the one or more images;
responsive to receiving, at the first mobile device, a selection of one of the one or more images:
a) displaying, at the first mobile device, one or more specifications characterizing the item depicted in the selected image;
b) displaying, at the first mobile device, any customer-submitted images, respectively corresponding to the item depicted in the selected image; and
c) displaying, at the first mobile device, any customer-submitted reviews respectively corresponding to the item depicted in the selected image; and
receiving instructions, at the first mobile device, to facilitate purchasing any of the individual items on behalf of the prospective customer.
